(19) United States
(12) Patent Application Publication
(10) Pub. No.: US 2021/0121721 A1
(43) Pub. Date: Apr. 29, 2021

(54) 24-7 Offsite Structural/Nonstructural Exterior Fire Detection Protection And Method

(71) Applicant: Guy Duane Phillips, Nicasio, CA (US)

(72) Inventor: Guy Duane Phillips, Nicasio, CA (US)

(21) Appl. No.: 16/667,724

(22) Filed: Oct. 29, 2019

(51) Int. Cl. A62C 3/02; G08B 17/12; G08B 25/10; A62C 37/36

(52) U.S. Cl. CPC A62C 3/0214; A62C 37/04; G08B 25/10; G08B 17/125

(57) ABSTRACT

This invention embodies a 24-7 fire protection system for fires originating outside of a structure. The invention integrates stand-alone, facility-based fire protection systems, control module and video and thermal sensors with offsite control functionality at the offsite Fire Defense Center (FDC). through multiple, redundant communications systems. Trained operators use sensor input and additional data streams to monitor fire threat in real time and deploy onsite optimized structure defense systems at the optimum time. System can be deployed onsite, remotely by an authorized facility owner/manager (via mobile application or Internet connection) or, by an autonomous control system in pre-set specified emergencies. This invention embodies the mapping, pipe and valve layout, and devices to cover the structure and, if desired, surrounding defensible spaces with a gel-water mix. The invention's gel-water mix provides protection for 48 hours, depending on humidity, more than enough for a fire front to pass the structure.

This invention embodies a facility monitoring system that includes a monitoring station receiving inputs from different onsite and offsite sources, each monitored and reported to an offsite Fire Defense Center (FDC) and trained system operator who will combine that with additional electronic supporting data systems to monitor fire threats and deploy fire protection materials as and when needed. Data from the inputs are scanned, segmented into categories and presented in a standard format including categories for the level of fire threat and condition. The FDC also stores graphic information regarding the site, orientation, and location of the fire protection equipment.

The FDC is equipped with high speed, high storage capacity redundant computers programmed to receive data from an Onsite Control Center (“OCC”). The FDC operator receives real time information from the OCC, 1^{st} responders, and other sources to monitor the nature and extent of fire threat facing the structure and, based on the information received, make the determination whether, when, and how much of a gel-water-based fluid to deploy through a strategically designed existing network of pipelines, valves, and deployment devices to the exterior of the structure. Similarly, the FDC operator will then purge the system and make it ready for another deployment should circumstances warrant.

At the location of the OCC, a skid mounted pre-packaged array of equipment including water storage tanks (for mixing, purging, gel storage, and gel-water mixing, pumping using a combination of micro-pumps at the tanks and a high capacity hydraulic pump for distribution through the pipelines and deployment devices. Back-up power is provided through a 6V DC AGM battery back that is set to switch in milliseconds in the event that electric utility power is lost. Meanwhile, the utility power keeps the batteries fully charged through a standard “trickle charger”.

Control over the maintenance, monitoring, and operation of the system is maintained in four integrated ways to ensure maximum reliability through redundancy: (1) direct wireless communication between the FDC and the OCC, (2) In an emergency if wireless communication is lost, the onsite owner/occupant/manager may unlock the OCC control and switch it on manually. (3) In an emergency if wireless communication is lost and the site owner/occupant/manager is not present, an authorized person may unlock the OCC control and switch it on remotely through a cell phone APP. Or, (4) In an emergency if wireless communication is lost and no authorized person is onsite, the OCC itself is programmed with an autonomous operation capability if site conditions meeting specified conditions and no person has acted to initiate the system.

The OCC monitors the site through a strategically placed network of thermal imaging and video cameras linked wireless to the OCC. The network provides real-time thermal, then to video when specified parameters are met (for protection of onsite privacy) site information up to ½ mile distant, data to the OCC and on to the FDC which then may take action as appropriate. This invention's features distinguish it from other art in multiple ways that are further described in detail below and for which 27 separate claims of embodiment are made below:
1. The invention's technology to operate the FDC, its inputs, management of those inputs, communication with other locations (including the OCC), and presentation technology to present the data to the FDC operator in a standardized, organized, quickly read, and quickly understood format. As described below, prior art does not address this embodiment which, as such, provides 24-7 monitoring, threat assessment, fire protection, and fire suppression from externally derived fire threats.
2. The invention's technology to organize the site and fire threat data received by the FDC into permanent storage and rapid retrieval in an understandable textural and graphic format including maps of the site and the location(s) of structure(s) and system components. As described below, prior art does not possess this embodiment.
3. The invention's technology to operate the OCC and its four modes of redundancy described above. As described below, prior art does not possess this embodiment.
4. The invention's technology to provide onsite and the FDC with system status reports, 247 communication with the FDC on nature, extent, and action required (if any) of any fire threats in the region of the site. As described below, prior art does not possess this embodiment—at least not in the context of the integrated comprehensive means of this invention for fire monitoring, protection, and suppression.
5. Similarly, the invention's technology to detect in milliseconds and communicate immediately onsite and to the FDC signals in the event of a fault of any kind in the system. Again, as described below, prior art does not possess this embodiment.

### CROSS-REFERENCE TO RELATED APPLICATIONS

This application claims the benefit of Provisional Application No. 529169685 entitled “A 24-7 Home Wildfire Detection and Suppression System,” filed Nov. 1, 2018 which is incorporated by reference in its entirety.

### STATEMENT REGARDING FEDERALLY SPONSORED RESEARCH OR DEVELOPMENT (IF APPLICABLE)

Not applicable.

### REFERENCE TO SEQUENCE LISTING, A TABLE OR A COMPUTER PROGRAM LISTING COMPACT DISC APPENDIX (IF APPLICABLE)

Not applicable.

### BACKGROUND OF THE INVENTION

Wildfires and fires triggered by earthquakes and other natural disasters have plagued mankind for centuries. In recent years, the threat of major fires has increased dramatically throughout the globe. In the western U.S., the size of the “average” wildfire has doubled while the frequency has increased along with the length of the fire season itself. The consequence of these conditions is that tens of thousands of homes and other structures are lost each year, hundreds of lives lost, and thousands more lives torn apart. The insurance industry, banking/mortgages, real estate markets suffer unknown extraordinary risks and losses.

Similarly, fires triggered by natural disasters, such as earthquakes, have become a major concern for urban areas where populations could have very little ability to evacuate (e.g., streets clogged with debris and/or traffic), fire departments have limited firefighting capability, and the same transportation routes that limit the population's movements also limit the portability of firefighting equipment/trucks and other 1^{st} responders (e.g., ambulances and medical personnel).

Just as emergency personnel and equipment have become increasingly overwhelmed at the challenges posed by the threat, the need for readiness (at unknown locations of unknown size), and the need for rapid response (more rapidly than ever before to protect against the situation from becoming totally out of control), professionals have judged that what is needed is better protection and control systems at the site itself.

In short, existing art and technique is inadequate and outdated for today's and tomorrow's requirements. Prior art devices available today are generally limited to discrete parts of the fire threat and are also greatly limited by their management systems technology.

Existing art's exterior fire protection systems do not provide 24-7 offsite monitoring and protection. As such, those systems incentivize the structure manager/owner to remain onsite and not evacuate when ordered. Or, such systems provide inadequate protection if shelter-in-place is ordered by authorities when evacuation is not feasible or safe.

Further, other, prior art exterior fire protection systems either: (1) rely on someone onsite to deploy a foam, gel, or water that soon dries out or evaporates, (2) rely on someone onsite to deploy some kind of protective physical barrier that can trap occupants from evacuating or cause other threats to life and safety if shelter-in-place is the order, (3) require operating electric and water supplies when, in fact, power is typically shut off in fire situations (thereby also eliminating electricity to deliver water), (4) do not provide protection through automatic shutting of potential fire fuel sources such as gas/propane lines, (5) cannot provide fire protection to defensible space and valuable landscaping, (6) have no means to monitor the state, direction, and condition of nearby fire threats and report same to the system operator, and (7) are not approved by the US Forest Service and the Environmental Protection Agency for fire protection and the ease of subsequent post-fire clean up.

For the prior art that relies on a moisture “curtain” over the structure from water, foam, or gel, such protection is useful only until the moisture has been evaporated by the fire or heat (e.g., dry humidity). The curtain offers little protection from the ember showers that are estimated to cause about 90% of wildfires. Such embers can blow through or under the curtain and lodge where a fire might soon result. Even then, the curtain must be deployed at the right time and in the right manner by an untrained site owner/occupant.

Further, some exterior fire protection systems are really only component parts to a more comprehensive fire protection approach—that prior art does not provide. That is, louvered vent screens, door closers, flaps, and the like provide limited protection in so far as they limit penetration into the structure from fire or embers through exiting openings (approximately 90% of wildfire losses are caused by flying embers and ember-storms). As such, they do not protect the exterior of the structure itself or its surrounding defensible spaces. So, the structure may burn down but the louvers and vents will remain.

Further, some exterior fire protection coating systems such as protective paints or other surface coverings provide only short duration, one-time, protection because they offer only a limited “air-block” between the fire and the structure. As such, they do not protect the overall exterior of the structure itself or its surrounding defensible spaces.

Finally, some exterior fire protection systems when deployed involve major clean-up efforts after the fire risk is gone. Some of the materials used for the fire protection contain chemicals that are themselves risky or even hazardous at the clean-up stage—or leave a residue in the soil that could render the soil unacceptable.

Interior fire sprinkler systems have been proven but, in part because they are designed for confined spaces, do not provide coverage or protection from fires originating from outside of the structure until and unless the fire penetrates the structure enough to produce heat or smoke to trigger the interior sprinkler. By then, the exterior of the structure may be fully engulfed in flames.

### CLASSIFICATION

A62D 1/0064 Fire-extinguishing compositions; Use of chemical substances in extinguishing fires: gels

### RELATED ART

| | Priority | Publication | | |
|---|---|---|---|---|
| Publication number | date | date | Assignee | Title |
| US20120298381A1 | 2011-01-27 | 2016-06- | W S Darley | Self-testing and |
| | | 28 | and Co | selfcalibrating fire sprinkler |
| | | | | system, method of |
| | | | | installation and method of |
| | | | | use |
| US5936531A | 1998-03-06 | 1999-08- | Powers; | Electrical fire sensing and |
| | | 10 | Frank A. | prevention/extinguishing |
| | | | | system |
| US6857478B1 | 2003-01-29 | 2005-02- | Junata E. | Packaged residential fire |
| | | 22 | Weber | sprinkler system |
| US6229429B1 | 1998-05-15 | 2001-05- | Daniel J. | Fire protection and |
| | | 08 | Horon | security monitoring system |
| US1585146A | 1924-04-10 | 1926-05- | PacificMarine | Forest-fire-fighting |
| | | 18 | Supply | apparatus |
| | | | Company | |
| US1694574A | 1925-08-10 | 1928-12- | American La | Motor fire apparatus |
| | | 11 | France And | |
| | | | Foamite | |
| US3770060A | 1972-12-26 | 1973-11- | Lockheed | Modular firefighting unit |
| | | 06 | Aircraft Corp | |
| CN204632039U | 2015-05-18 | 2015-09- | Chinese | Forest fire prevention |
| | | 09 | | monitoring device |
| CN106530577A | 2016-12-30 | 2017-03- | Chinese | Forest fire early-warning |
| | | 22 | | system based on Internet |
| | | | | of Things |
| US4037664A | 1975-11-10 | 1977-07- | Gibson Motor | Firefighting-foam |
| | | 26 | And Machine | producing module |
| | | | Service, Inc. | |
| US4488603A | 1977-03-28 | 1984-12- | Dr. H. | A compact and highly |
| | | 18 | Schmittmann | mobile fire-fighting |
| | | | Gmbh | vehicle |
| US6719065B2 | 2001-04-02 | 2004-04-13 | Carba Fire | Firefighting apparatus with |
| | | | Technologies | spray bar |
| US5553673A | 1994-03-22 | 1996-09-10 | Simon | Modular self-contained |
| | | | Ladder | pump unit for vehicle |
| | | | Towers, Inc. | mounting |
| US4729434A | 1986-04-28 | 1988-03-08 | Rohrbach | Portable fire-fighting |
| | | | Jerry T | apparatus |
| US5123490A | 1990-09-18 | 1992-06-23 | Jennings | Self-contained smoke |
| | | | Charles E | activated fire extinguishing |
| | | | | flooding system |

### BRIEF SUMMARY OF THE INVENTION

The present invention consists of an integrated system that provides 24-7 real-time offsite monitoring of fire threats facing one or more structures from a centralized “Fire Defense Center” (“FDC”) and, when threats are detected, protect the structure(s) and/or suppress fires approaching the structure(s) with an externally-applied fire sprinkler systems using a gel-water mixture. More particularly to deploy a fire sprinkler system assembled as a complete package from UL listed components including but not limited to: (a) independent water and electricity supplies, (b) hydraulic pump/motor, (c) electric system computerized controller, (d) all required plumbing, pipe, fittings, manifold assembly, ball valve, flow switches, pressure switches, pressure gauges, and dual click valves. Except for the camera network and deployment plumbing (pipelines and sprinklers), all of the components are mounted at a single location on a high-density polyethylene skid-base. The invention is designed for use on residential structures and outbuildings as well as small-to-medium sized commercial, agricultural, and industrial sites (this embodiment offers additional optional water storage tanks).

### BRIEF DESCRIPTION OF THE SEVERAL VIEWS OF THE DRAWINGS

For a further understanding of the above and other features and advantages, reference is made to the detailed description and to the drawings, in which:

FIG. 1 schematically represents the overall layout, relationships, and data flows between the site, the FDC, and 3^{rd}-party sources of data.

FIG. 2 is a diagram of the hardware components and their relationships within the OCC and to the FDC.

FIG. 3 Is a summary of the equipment in the OCC.

### DETAILED DESCRIPTION OF THE INVENTION

Prior art systems utilize existing water supplies which are plumbed into the residence. These systems are often powered by the domestic power supply. Reliance on public utilities offers little or no protection in the event of catastrophic failure of either (or both) the water or power supply.

Further, prior art systems use water, foams, or gels that provide only limited, short duration, protection of the structure(s) and, as a result, cannot be redeployed unless someone has remained at the site during dangerous conditions (e.g., after an evacuate order has been given).

The prior art systems that use foams or other gels for protection do not provide for means to purge the system after use such that the foam or gel may clog the dispersal equipment and render it unusable and potentially difficult and expensive to clean up after use.

Some of the prior art systems have not been approved by the relevant authorities for such use or, may contain chemicals that create a significant clean-up problem when used.

Some prior art systems utilize physical barriers such as drop-down shields to protect structures. Unfortunately, such barriers may also limit the ability of the occupants to evacuate when necessary.

Further, some prior art systems require the owner/occupant to: (a) design the specific application for that site, (b) order the component parts, (c) install the parts somewhere, (d) maintain the readiness of the system, (e) evaluate the nature of the threat and decide when to deploy the system, (f) operate the system on-site, and (g) clean up a contaminated site after deployment. This invention does not require the owner/occupant to do any of those things except, in emergency conditions, item (f).

It is therefore, a principal object of this invention to provide a new, useful and uncomplicated method and apparatus for selecting and installing the corresponding pumping and controlling means for a highly effective gel-water mixture to be supplied to a fire sprinkler grid in a residence or other building.

It is a further object of the invention to provide interconnected communication between onsite systems, the FDC, the site owner, 1^{st} responders, and other sources of information to monitor the situation, determine the presence and degree of threat, and respond as-and-when appropriate (not too early and not too late) with the gel-water mix to the structure(s) and surrounding defensible space(s) as required.

It is a further object of the invention to provide completely packaged compact and interconnected systems mounted on a skid consisting of, for example, pump/motor, controller, manifold assembly all mounted on a polyethylene base, pre-wired and piped.

It is a further object of the invention to provide a range of system sizes and components tailored to the specific requirements of large and small structures.

It is a further object of the invention to provide off-site monitoring and control of the systems so that the owner(s)/occupants of the structures will be able to evacuate when and if an evacuation order is given by local authorities without sacrificing structure protection. Similarly, if the order to “shelter-in-place” is made, the object of the invention is to make the structures “survivable space” through a fire, as compared for example, to other art that effectively locks the occupants into the structure whether it is safe or not.

The present invention achieves these objectives. It provides for FDC off-site fire monitoring, threat assessment, and suppression apparatus suitable for, but not limited to, residential, condominium, apartment, mobile home, small-to-medium size schools, portable buildings, barns, warehouses, offices, trailers and other applications where the potential of fire threatens safety and structures. This is particularly relevant where: (a) water is scarce, (b) where wells and domestic water may have insufficient flow or are powered by an electric grid that could go down, (c) where organized fire protection is limited, overwhelmed, or non-existent, or (d) where ingress and egress access is limited and constrains movement of 1^{st} responders and the occupants.

The invention offers back-up supply of both power and water sources, including, but not limited to, the emergency condition where such a supply is catastrophically interrupted using a battery bank back-up capable of taking electric control over the system in milliseconds. The latter system is designed to provide an instantaneous and secure supply of electricity to the controller and fire pump managed by the FDC. If wireless communication is also lost, the system can be operated on an emergency basis through a manual switch or a mobile APP, or, if communications are completely compromised, by an onsite autonomous control system.

The invention operates from the electric grid as long as possible to keep the batteries charged, water supplies full, and to do 24-7 monitoring and reporting to the FDC. An auto charging “trickle charger” is standard, the power system is automatically protected against overdischarging, overload or over-charging with reset capabilities. The skid-mounted package is installed with all wiring and plumbing included.

The invention provides for a hydraulic pump having a casing, impeller and shaft of stainless steel construction and rated for the liquid handling of the gel-water mix for corrosion resistance and long life.

The invention's OCC/controller component is mounted in a strong, steel U.L. Listed NEMA-3R enclosure with a locking door. The OCC provides integrated management of all system components and is the system interface for external management by the FDC or, in emergencies, by an onsite operator, APP, or autonomous system controller. The control panel has, among other devices: (a) power on monitoring lights (“power and readiness light indicators”, (b) voltage line meters, (c) manual start emergency mechanical run and associated valves, (d) pressure switches, (e) wireless communications to onsite sensor/camera(s), and (f) support for direct cellular connectivity. As an integral part of the skid, the controller is supplied ready to be connected to a utility power source and the power back-up system.

The invention pump/manifold assembly is constructed using all brass fittings and includes a dual check valve with a U.L. water pressure gauge, U.L. Listed pressure and water flow switches, a U.L. brass full port ball valve with a locking handle for security. The invention pump manifold assembly is supplied ready to be connected to the sprinkler.

The invention's skid mounted multiple water tanks range in size from a 50 gallon up to 1,500 gallon tanks (which could be either above or below ground, in which case they would not be mounted on the skid).

### OBJECTIVES AND FEATURES OF THIS INVENTION AND DETAILED DISCUSSION OF THE FIGURES

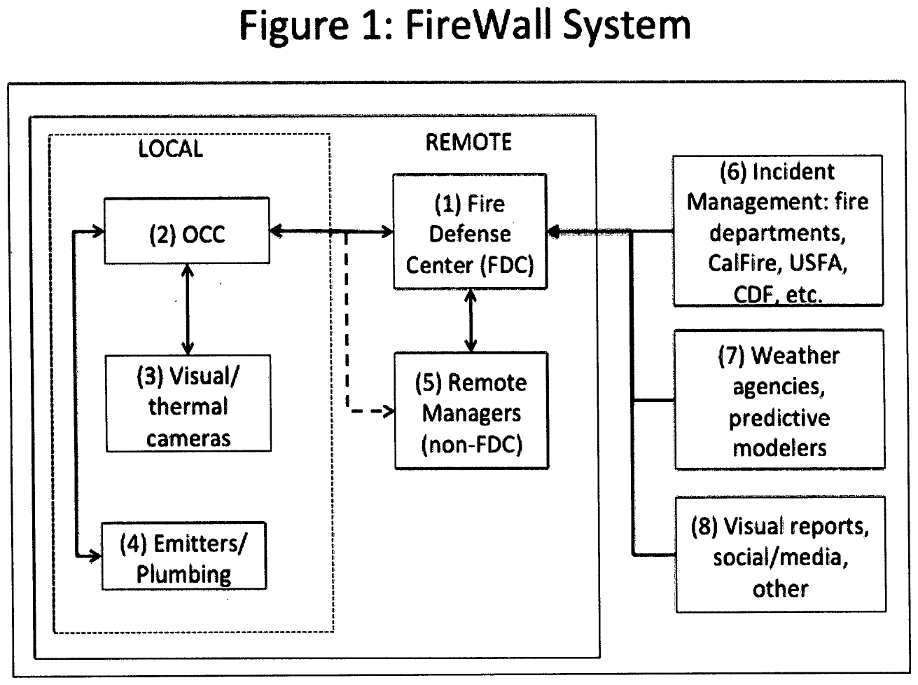

The present invention relates to a 24-7 real-time interconnected system enabling an offsite Fire Defense Center (“FDC”) to monitor a structure or structures such as a building or complex of several buildings and when threats are detected, deploy a gel-water based fire protection and suppression system as needed. More particularly the FDC (FIG. 1(1)) receives inputs from several sources at the site and additional data inputs from 1^{st} responders, the weather bureau(s), on-the-ground observers, and broadcast media.

The “Fire Defense Center” (FDC), FIG. 1(1) will determine the level and timing of threat posed by an approaching fire and in order to deploy the water-gel fire suppression system as appropriate and at the optimal time prior to the fire front or ember storm's arrival so as to maximize the system's protective effects.

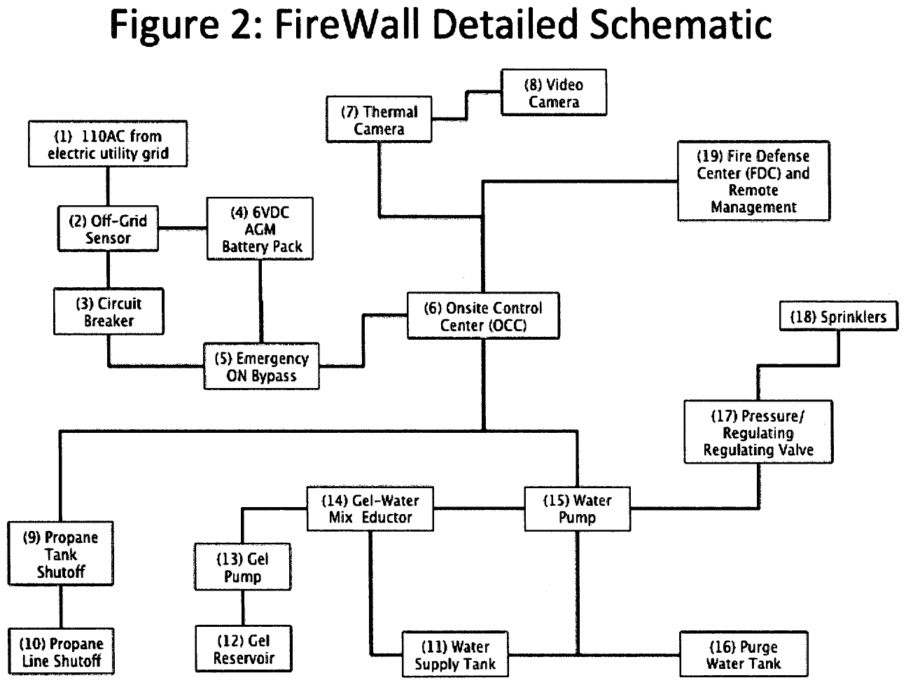

The FDC receives inputs communicated via wireless connection direct from an onsite camera system that is capable of thermal imaging, video imaging, and relaying said information to the FDC. The FDC, in turn, has wireless communication to the onsite command center (OCC, FIG. 2(6)) through which the FDC can monitor the condition, performance, and operation of the fire suppression system (including turning the system on/off at the FDC, or, in emergencies by an onsite operator at the OCC or through a cell phone APP). In the unlikely event of a collapse of the wireless network, the OCC is equipped with a sensor to detect if such an event occurs and switch automatically to an IP control system.

FDC operators can control the orientation of the onsite camera(s) system, sprinkler valve opening/closing order, filling tanks, mixing the gel-water mix, and deploying the mix.

Once triggered, the fire suppression system deploys a gel-water mix that was prepared at the OCC automatically when such signal is sent by the FDC through a series of valve-controlled high-pressure high-capacity multi-nozzle sprinkler emitters located strategically around the structure(s) in order to cover the structure(s)—from the roof down and from the ground up—so that all surfaces and niches that might trap hot embers are treated.

Prior to mixing, the gel and the water are stored separately in their own respective tanks (FIG. 2 (11) and (12)). Transmission is through 1½″ or 2″ pipes, (depending on site conditions).

Stand-alone independent water supply for the system is maintained in a large water tank sized for the particular application. That, in turn, is supported by another tank containing the gel. Both are transmitted through a manifold to a 3^{rd} tank—the mixing tank to mix the gel and water in the proportions to maximize the effective use of the mixture and to maximize its longevity once deployed (FIG. 2(14)). Another tank contains a supply of “purge” water to clear the lines and sprinklers of any gel-water mix after use (FIG. 2(16)).

Stand-alone independent electricity supply for the system is first provided by the electric grid to run the system if possible and to maintain the state of charge in the back-up system through a “trickle charger” (FIG. 2(4)). In the event that the electric grid fails or is shut down by the utility company, a sensor automatically detects the loss of grid power and switches on the battery backup which is comprised of a bank of 6-volt deep cycle AGM batteries that are kept charged by the grid until needed for back-up.

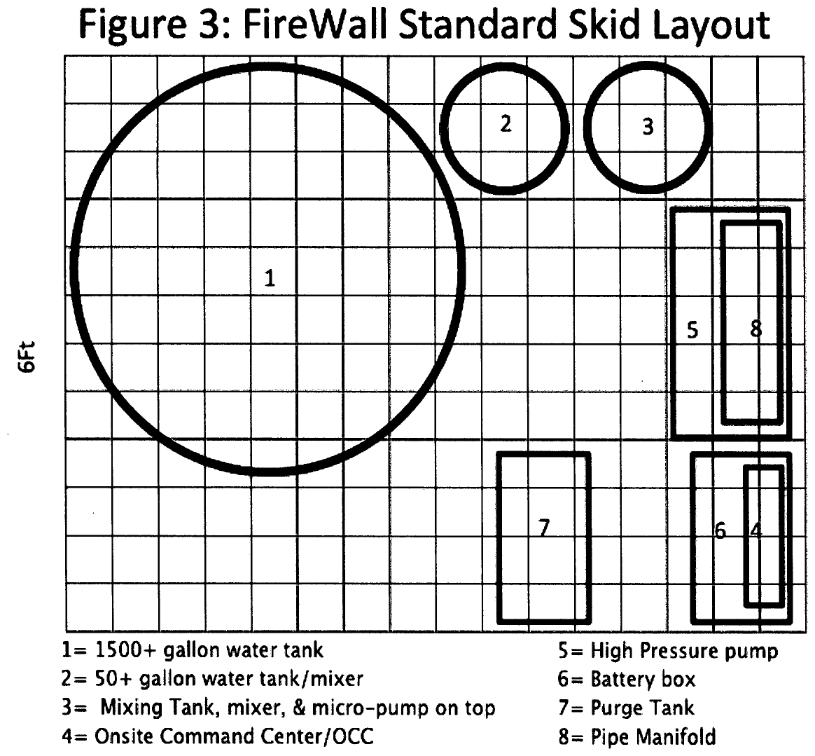

Control for the onsite monitoring and operation of the system is performed through the OCC mother board circuit FIG. 2 (6) and FIG. 3 (4) on the OCC skid. The OCC monitors all onsite components to ensure proper operation and sends a signal to the FDC in the event that any component is not operating within specifications. Similarly, the OCC receives signals from the FDC regarding system operations and whether to deploy or purge the system.

Therefore, it is an object of the present invention to provide the FDC messages from a variety of sensors and control panels through the mother board are presented to the FDC in a consistent, uniform format that in turn relates to the site maps of the structure, the invention, and surrounding area. To handle the constant stream of data, the FDC computers will have 3 related alarms: (1) system not operating within specifications, (2) thermal energy detected in the specified temperature ranges, and (3) time to switch to video monitoring and possible deployment of the system.

Further, the FDC will be equipped with a facility monitoring system with graphic capabilities for displaying a site map in combination with images representing the various system devices as to type, state (or condition) and location. Thus, the FDC will be able to communicate to the site owner, 1^{st} responders, and others as needed in order to assist with fire protection, fighting, and post-fire threats or other requirements.

To achieve these and other objectives, the control panels that support detectors and other devices are integrated with one another. While these circuits differ from one another as to certain specific data reported, the communication language will be common to all. That is, prestored operating protocols/standards, and presets are real-time compared to the data provided by all of the circuits, with the result being a uniform presentation of matched information and performance. If the reported data does not fall within the preset protocols, an alarm is sent to the FDC. Similarly, in deployment mode, the preset standards monitor when, how much, and how often the gel-water mix is deployed. As such, the system operator is not confused by a blizzard of different formats, words for specific devices, phrases for messages related to certain alarm conditions, etc. The operator is more likely to respond to an emergency condition more rapidly and more appropriately when receiving information in a common language and standard format.

Thus, in accordance with the present invention, the facility monitoring system (OCC and FDC) can receive information from different types of control circuits and manage the system appropriately whether inactive or in deployment modes. The present invention also uses that common language to detect whether any particular component of the system needs maintenance or replacement. As a result, repair personnel can visit the site with the knowledge of what they need to do and what equipment/supplies they should bring. This will greatly reduce “down” time as well as the costs associated with ongoing maintenance, repairs, and replacements.

The following detailed description of the present invention is given for explanatory purposes. It may be apparent that changes and modifications may be made without departing from the scope of the invention. Accordingly, the whole of the following description is to be considered in an illustrative and not a limiting sense, the scope of the invention being defined by claims.

Shown in FIG. 1 provides an overview of the system for monitoring a building, complex of buildings or other facility for fire protection and other security. This figure illustrates both hardware and software (computer program) components of the system, which includes a central monitoring station (FDC) and several panels and associated devices coupled to the FDC through the OCC. The 8 boxes in FIG. 1 include:

Box (1) The Fire Defense Center (FDC) receives input data from the site (thermal and video) and from 1^{st} responders and others where useful information about the specific location, size, pattern(s), direction and rate of movement, fuel sources and conditions, wind speeds, weather forecasts, and movements of personnel on the ground (e.g., fire fighters). Based on this information the FDC can monitor 5 conditions: (a) system operating normal and no threats detected, (b) a thermal threat has been detected, time to switch to video monitoring, (c) time to deploy the gel-water mix, (d) time to purge the system, and (e) time to re-deploy the system (e.g., if too much time has elapsed since the first deployment and the gel-water mix may be losing some of its effectiveness: typically at least 4 hours—usually enough time for the fire front to have passed the site. Then repeat steps (c) and (d).

Box (2) The OCC unit at the structure(s) monitors the system through the 5 conditions described above and reports same through a wireless communication with the FDC as transmitted from the SCP.

Box (3) The thermal/video wireless camera system is mounted on the structure(s) to monitor and report conditions and threats at and around the site (up to ½ mile) through the OCC to the FDC.

Box (4) Represents the pipelines and emitting valves to distribute the gel-water mix and cover the structure as designed for the specific site.

Box (5) Represents the potential emergency situation where wireless communication is compromised (such that the FDC cannot communicate with the site) and where, under specified emergency conditions an authorized operator may enter by keypad the requisite code to unlock the local OCC and operate the system either onsite or via a cellphone APP from offsite. Further, this invention provides that, in specified emergency conditions and when communications have been compromised, an autonomous system within the OCC will detect same and initiate an autonomous operating function within the OCC.

Box (6) First responders all communicate with each other through wireless and report to their respective command posts. The FDC also receives those inputs and matches those with the structure(s) for which this invention has been installed. The information helps the FDC to monitor fire patterns and trends, and the level of threat faced by the structures from distances outside the range of the camera in (3). The FDC can then determine whether, when, and how much to deploy the invention.

Box (7) The weather agencies have global, regional, and local conditions (temperatures, humidity, wind direction, etc.) that can help to evaluate the level of threat and nature of any deployment that might be required at the FDC.

Box (8) In advance of any evacuation order that might be coming, there are almost always people on the ground (residents, utility personnel, media, etc.) who can give firsthand accounting of the situation. Based on the site and neighborhood information being received by the FDC and the maps at the FDC, the FDC may be able to identify a safe exit route for occupants if an evacuation order is given by authorities.

FIG. 2 illustrates the system flow respectively from the utility electric grid on the left to the FDC on the right. FIG. 2 demonstrates the process through which management, monitoring, and deployment of the system by the FDC (Box 19) or, in an emergency someone onsite or through a cell phone APP. The 6-volt DC devices for grid sensing, battery charging, auto “on” control, are controlled by sensors that, in turn, are controlled by the OCC (Box 6) in communication with the FDC.

Following is a description of each of the boxes in the illustration. Minimal floor space is required and the pre-package pump/controller of the invention are assembled on a skid prior to delivery to the site.
1. Grid connection from electric utility.
   a. Technology: simple standard utility-approved grounded interconnect to 110 AC (e.g., as used in solar energy applications)
   b. Specifications/work being done. Electric grid interconnect.
   c. Equipment and specifications of the equipment. Standard interconnect device.
2. Grid OFF sensor: detect if the electric grid goes down and to maintain uninterrupted power, automatically start back-up power.
   a. Technology: simple tester with auto-start for generator
   b. Specifications/work being done: switch to back-up power.
   c. Equipment and specifications of the equipment: standard interconnect sensor and switching device to switch to battery back-up in milliseconds, together with a standard UL approved inverter to convert the AC to DC.
3. Circuit breaker: simple circuit breaker or fuse box for the utility connection
   a. Technology: simple circuit breaker box
   b. Specifications/work being done. 30 amp circuit breaker box
   c. Equipment and specifications of the equipment. 30 amp circuit breaker box
4. 6-volt AGM back-up battery pack.
   a. Technology: dedicated diesel or gas fueled generator
   b. Specifications/work being done: when activated, supply electric power to the OCC's functions.
   c. Equipment and specifications of the equipment: deep cycle AGM lead-acid batteries
5. Emergency Bypass System On/off switch
   a. Technology: standard breaker switch equipped with a locking door that can only be opened with a predetermined code.
   b. Specifications/work being done. Provide for emergency operation of the system if communication with the FDC is disrupted.
   c. Equipment and specifications of the equipment. Standard simple “lock-off” switch that can be manually switched in an emergency by an authorized person with the requisite security code.
6. Onsite Command center (OCC)
   a. Technology: Customized standard thermal/video camera with wireless capability.
   b. Specifications/work being done: direct satellite wireless connection to/from site to FDC.
   c. Equipment and specifications of the equipment: The controller enclosure is a strong, steel, U.L. Listed, NEMA-3R, with a locking door for security. Controls are designed to provide complete automatic operation. All components are pre-wired including a terminal strip. The control panel is clearly marked with a digital meter display for volts and amps. The OCC is fitted with operator displays such as: manual run light, power stop/reset, circuit breaker disconnecting mechanism, phase error light, gauges, etc.
7. Thermal camera
   a. Technology: For demonstrative purposes, the FLIR C3 Pocket Thermal Camera with WiFi.
   b. Specifications/work being done. Thermal/video/wifi all-in-one camera.
   c. Equipment and specifications of the equipment. For demonstrative purposes, internal memory, at least 500 sets of images. Peer-to-peer (ad hoc) or infrastructure (network).
   MSX: Adds visual details to full resolution thermal image. Thermal Image: Yes. Visual Image: Yes. Visual Video Streaming: Yes. Object Temperature Range: −10° C. to 150° C. (14° F. to 302° F.). Battery: 3.7 V Rechargeable Li-ion polymer battery. Battery operating time: 2 hours. Charging system: Charged inside camera. Charging Time: 1.5 hours. External Power Operation: AC adapter, 90-260 VAC input—5 V output to camera (so we'll need some kind of continuous charging system). Image File Format: Standard JPEG with 14-bit measurement data included.
8. Video camera (same as #8)
   a. Technology: see #8
   b. Specifications/work being done. On signal from FDC, switch from thermal camera to video.
   c. Equipment and specifications of the equipment. For demonstrative purposes, the FLIR C3 Pocket Thermal Camera with WiFi.
9. Propane Tank shut-off valve
   a. Technology: Wireless shut-off operated either by the FDC or, in emergency, the owner/operator (see #6 above).
   b. Specifications/work being done. Closing the propane tank valve at the tank.
   c. Equipment and specifications of the equipment. Standard wireless connector and valve.
10. Propane line @ structure shut-off valve
   a. Technology: Wireless shut-off operated either by the FDC or, in emergency, the owner/operator (see #6 above).
   b. Specifications/work being done. Standard brass-wireless equipped valve to close the propane valve at the house.
   d. Equipment and specifications of the equipment. Standard wireless connector & valve.
11. Water Supply Tank
   a. Technology: 1,500 gal poly tank, ANSI/NSF Certified Standard 61
   b. Specifications/work being done. Water storage
   c. Equipment and specifications of the equipment. For demonstrative purposes, a 1500 Gallon Poly vertical Storage Tank. With an electric valve to purge the water line after use. Water feed from tank to mixing tank via a 12V DC micro-pump. The tank will be filled and levels maintained by the water source external to the system and managed with an automatic water fill valve and float assembly and other options. If the external water supply is lost, the tank already has enough water for two deploy-purge cycles.
12. Gel Reservoir
   a. Technology: 40 gal poly tank, ANSI/NSF Certified Standard 61
   b. Specifications/work being done. Gel storage
   c. Equipment and specifications of the equipment. For demonstrative purposes, a 50 gal poly tank approved for storing chemicals that is used for gel only. With a reversible valve to purge the gel line after use.
13. Gel pump
   a. Technology: UL approved standard DC powered electric micro-pump
   b. Specifications/work being done. Pump Gel from its dedicated storage tank to the mixing tank.
   c. Equipment and specifications of the equipment. Standard brass valve(s) with pressure controls specific to the site and structure(s).
14. Gel-water mix eductor
   a. Technology: Standard 12V DC timer to control the mixing equipment in a 50+ gallon poly tank ANSI/NSF Certified Standard approved for chemicals.
   b. Specifications/work being done. Periodic stirring of the gel to maintain proper consistency and avoid stratifying.
   c. Equipment and specifications of the equipment. Electric auto control of a mixing apparatus similar to the paddle-type mixers used for paints (the gel is of approximately the same consistency/density).
15. Water Pump
   a. Technology: standard high volume, high pressure, hydraulic pump.
   b. Specifications/work being done. Pumping water through a (1½″ to 2″) pipeline to sprinklers to be mixed with gel at the sprinkler. The design pressure will be the pressure in P.S.I. that will be required by the sprinkler head at the furthermost point, as adjusted for elevation and friction loss in the pipe for the final total pressure requirement.
   b. Equipment and specifications of the equipment: For demonstrative purposes, a Hydrel Double Diaphragm Air Pump, 153 gpm.
16. Water flush-purge water tank/line (see #9)
   a. Technology: 40+ gallon poly tank to store fresh water for line purging.
   b. Specifications/work being done. Valve to purge water line after use.
   c. Equipment and specifications of the equipment. Standard fresh water storage tank fitted with a micro-pump to pump the purge water to the hydraulic pump #14.
17. Water Pressure Regulating Valve
   a. Technology: Standard brass valve(s) with pressure controls specific to the site.
   b. Specifications/work being done. Maintain the proper water pressure at the sprinklers and their respective zones.
   c. Equipment and specifications of the equipment. Electric valve to increase/decrease pressure.
18. Sprinkler(s)
   a. Technology: standard
   b. Specifications/work being done. Dispense with the gel-water mix to the structure(s) in each zone according to design location, intensity, horizontal/vertical pattern, and length of time.
   c. Equipment and specifications of the equipment: For demonstrative purposes, the Strongway Sprinkler—1¼ in. Sprinkler Head with multi-nozzles, 150′ range, 63 gpm, RainCloud, R3000 Rotator, Sime Senior Impact Drive Sprinkler, 2″, 160 gpm, 260 ft diameter.

In FIG. 3, the respective components of the standard skid layout are:
1. Up to 1500 gallon water tank approved for long term water storage;
2. 50+ gallon water tank/mixer & micro-pump on top approved for storage of chemicals such as the gel; the mixer is to provide periodic circulation of the gel to ensure that it does not stratify. The micro-pump is to move the gel to item 3, the mixing tank.
3. Mixing tank, mixer, & micro-pump on top; this is where the gel-water mix is created at the proper proportions to deliver to the pipeline and sprinkler nozzles.
4. Control panel/OCC; Each control panel receives data from each of the devices on its circuits, and provides that data to the FDC monitoring station and the central processing unit (CPU). A high speed, high capacity computer will be employed to receive and store the data in predetermined format to then report the information to the FDC operator on a 24-7, real time, basis. The CPU will also integrate the data stream to a database, a display manager program for ease of reading and interpreting the data by the operator, including for example, device lists, graphics, and action messages. One or more printers are coupled to the system to generate reports which will be discussed below. Further, the OCC will have hardware components for a copy protect device known as a hardlock, a video display terminal for showing text and graphics, a cursor control, and a keyboard primarily for entering textual data.
5. High pressure hydraulic pump;
6. Battery box (when appropriate, this embodiment might include a portable diesel or gasoline powered generator);
7. Purge Tank;
8. Pipe Manifold this device regulates/controls the openings and closings of the valves for each of the fluid flows for water intake, gel-water mixing, pumping, and purging.

### PATENT CITATIONS (70)

| | | Publication | | |
|---|---|---|---|---|
| Publication number | Priority date | date | Assignee | Title |
| WO2002015415A3 | 2000-08-11 | 2002-06- | Kidde | Communication |
| | | 13 | Portable | protocol for |
| | | | Equipment | interconnected |
| | | | Inc | hazardous condition |
| | | | | detectors, and system |
| | | | | employing same |
| US5086385A | 1989-01-31 | 1992-02- | Custom | Expandable home |
| | | 04 | Command | automation system |
| | | | Systems | |
| S20110220372A1 | 2010-03-11 | 2014-03- | Gary Iken | Fluid storage and |
| | | 25 | | pumping assembly for |
| | | | | fire prevention and |
| | | | | protection |
| WO2013037352A3 | 2011-09-14 | 2013-10- | Thomas | Smoke or fire protection |
| | | 31 | Wegner | covering for closing a |
| | | | | building opening |
| US5400246A | 1989-05-09 | 1995-03- | Ansan | Peripheral data |
| | | 21 | Industries, | acquisition, monitor, |
| | | | Ltd. | and adaptive control |
| | | | | system via personal |
| | | | | computer |
| US20020075307A1 | 2000-09-28 | 2002-06- | Vigilos, Inc. | System and method for |
| | | 20 | | dynamic interaction |
| | | | | with remote devices |
| US20020124081A1 | 2001-01-26 | 2002-09- | Netbotz Inc. | Method and system for |
| | | 05 | | a set of network |
| | | | | appliances which can be |
| | | | | connected to provide |
| | | | | enhanced collaboration, |
| | | | | scalability, and |
| | | | | reliability |
| US20020161885A1 | 1999-10-27 | 2002-10- | Netbotz Inc. | Methods for displaying |
| | | 31 | | physical network |
| | | | | topology and |
| | | | | environmental status by |
| | | | | location, organization, |
| | | | | or responsible party |
| US20020174367A1 | 1999-09-01 | 2002-11-21 | Kimmel | Method and apparatus |
| | | | David E. | for remotely monitoring |
| | | | | a site |
| US6972676B1 | 1999-09-01 | 2005-12-06 | Nettalon | Method and apparatus |
| | | | Security | for remotely monitoring |
| | | | Systems, Inc. | a site |
| US6529137B1 | 1999-08-31 | 2003-03-04 | Compass | Method and apparatus |
| | | | Technologies, | for displaying alarm |
| | | | Inc. | information |
| EP1296301A2 | 2001-09-21 | 2003-03-26 | Hochiki | Fire alarm system, fire |
| | | | Corporation | sensor, fire receiver, and |
| | | | | repeater |
| US20030167335A1 | 2002-03-04 | 2003-09-04 | Vigilos, Inc. | System and method for |
| | | | | network-based |
| | | | | communication |
| US20030208480A1 | 2002-05-03 | 2003-11-06 | Netbotz, Inc. | Method and apparatus |
| | | | | for collecting and |
| | | | | displaying network |
| | | | | device information |
| US20030206172A1 | 2002-03-05 | 2003-11-06 | Vigilos, Inc. | System and method for |
| | | | | the asynchronous |
| | | | | collection and |
| | | | | management of video |
| | | | | data |
| US20040160897A1 | 1999-10-27 | 2004-08-19 | Netbotz, Inc. | Method and system for |
| | | | | monitoring computer |
| | | | | networks and equipment |
| US20040236718A1 | 2003-04-14 | 2004-11-25 | Netbotz, Inc. | Method and system for |
| | | | | journaling and accessing |
| | | | | sensor and configuration |
| | | | | data |
| US20040263351A1 | 2003-04-14 | 2004-12-30 | Netbotz, Inc. | Environmental |
| | | | | monitoring device |
| US20050188047A1 | 2003-10-27 | 2005-08-25 | Netbotz, Inc. | System and method for |
| | | | | network device |
| | | | | communication |
| EP1685544A1 | 2003-11-17 | 2006-08-02 | Honeywell | Monitoring system and |
| | | | International, | method |
| | | | Inc. | |
| US20060190960A1 | | 2006-08-24 | Barker | System and method for |
| | | | Geoffrey T | incorporating video |
| | | | | analytics in a |
| | | | | monitoring network |
| US20060238339A1 | 2003-04-14 | 2006-10-26 | Michael | Extensible Sensor |
| | | | Primm | Monitoring, Alert |
| | | | | Processing and |
| | | | | Notification system and |
| | | | | Method |
| US20070008099A1 | 1999-09-01 | 2007-01-11 | Nettalon | Method and apparatus |
| | | | Security | for remotely monitoring |
| | | | Systems, | a site |
| | | | Inc. | |
| US20080215727A1 | 2004-12-13 | 2008-09-04, | American | Remote monitoring |
| | | | Power | system |
| | | | Conversion | |
| | | | Corporation | |
| US7480715B1 | 2002-01-25 | 2009-01-20 | Vig | System and method for |
| | | | Acquisitions | performing a predictive |
| | | | Ltd., L.L.C. | threat assessment based |
| | | | | on risk factors |
| US20090164483A1 | 2007-12-21 | 2009-06-25 | Russell | Security event update |
| | | | William | protocol |
| | | | Miles | |
| US7711814B1 | 2004-12-13 | 2010-05-04 | American | Method and system for |
| | | | Power | remote monitoring of a |
| | | | Conversion | power supply device |
| | | | Corporation | with user registration |
| | | | | capability |
| US20100271220A1 | 2009-04-24 | 2010-10-28 | Pattok Greg | Detection Device |
| | | | R | System and Device |
| | | | | Thereof |
| US20110184563A1 | 2010-01-27 | 2011-07-28 | Honeywell | Energy-related |
| | | | International | information presentation |
| | | | Inc. | system |
| WO2011143273A1 | 2010-05-10 | 2011-11-17 | IControl | Control system user |
| | | | Networks, | interface |
| | | | Inc | |
| WO2012000523A1 | 2010-06-29 | 2012-01-05 | Lightstep | Control module for a |
| | | | Technologies | route guidance system |
| | | | Limited | |
| WO2012013976A3 | 2010-07-29 | 2012-03-29 | Cooper | Alarm systems |
| | | | Security | |
| | | | Limited | |
| USRE43598E1 | 2000-09-28 | 2012-08-21 | Vig | Method and process for |
| | | | Acquisitions | configuring a premises |
| | | | Ltd., L.L.C. | for monitoring |
| US8271626B2 | 2001-01-26 | 2012-09-18 | American | Methods for displaying |
| | | | Power | physical network |
| | | | Conversion | topology and |
| | | | Corporation | environmental status by |
| | | | | location, organization, or |
| | | | | responsible party |
| US8566292B2 | 2003-04-14 | 2013-10-22 | Schneider | Method and system for |
| | | | Electric It | journaling and accessing |
| | | | Corporation | sensor and configuration |
| | | | | data |
| WO2014075070A3 | 2012-11-12 | 2014-08-07 | Sielox, Llc | Emergency notification |
| | | | | system and methods |
| US8836532B2 | 2009-07-16 | 2014-09-16 | Gentex | Notification appliance |
| | | | Corporation | and method thereof |
| US20140365671A1 | 2013-06-06 | 2014-12-11 | Samsung | Computing system with |
| | | | Electronics | control mechanism and |
| | | | Co., Ltd. | method of operation |
| | | | | thereof |
| US8990536B2 | 2011-06-01 | 2015-03-24 | Schneider | Systems and methods for |
| | | | Electric It | journaling and executing |
| | | | Corporation | device control |
| | | | | instructions |
| US9170574B2 | 2009-09-29 | 2015-10-27 | Honeywell | Systems and methods for |
| | | | International | configuring a building |
| | | | Inc. | management system |
| US20160011751A1 | 2014-07-08 | 2016-01-14 | Honeywell | System and method for |
| | | | International | auto-configuration of |
| | | | Inc. | devices in building |
| | | | | information model |
| US20160274759A1 | 2008-08-25 | 2016-09-22 | Paul J. | Security system with |
| | | | Dawes | networked touchscreen |
| | | | | and gateway |
| US10051078B2 | 2007-06-12 | 2018-08-14 | Icontrol | WiFi-to-serial |
| | | | Networks, | encapsulation in |
| | | | Inc. | systems |
| US10062273B2 | 2010-09-28 | 2018-08-28 | Icontrol | Integrated security |
| | | | Networks, | system with parallel |
| | | | Inc. | processing architecture |
| US10062245B2 | 2005-03-16 | 2018-08-28 | Icontrol | Cross-client sensor user |
| | | | Networks, | interface in an |
| | | | Inc. | integrated security |
| | | | | network |
| US10078958B2 | 2010-12-17 | 2018-09-18 | Icontrol | Method and system for |
| | | | Networks, | logging security event |
| | | | Inc. | data |
| US10079839B1 | 2007-06-12 | 2018-09-18 | Icontrol | Activation of gateway |
| | | | Networks, | device |
| | | | Inc. | |
| US10091014B2 | 2005-03-16 | 2018-10-02 | Icontrol | Integrated security |
| | | | Networks, | network with security |
| | | | Inc. | alarm signaling system |
| US10127801B2 | 2005-03-16 | 2018-11-13 | Icontrol | Integrated security |
| | | | Networks, | system with parallel |
| | | | Inc. | processing architecture |
| US10142394B2 | 2007-06-12 | 2018-11-27 | Icontrol | Generating risk profile |
| | | | Networks, | using data of home |
| | | | Inc. | monitoring and security |
| | | | | system |
| US10140840B2 | 2007-04-23 | 2018-11-27 | Icontrol | Method and system for |
| | | | Networks, | providing alternate |
| | | | Inc. | network access |
| US10142166B2 | 2004-03-16 | 2018-11-27 | Icontrol | Takeover of security |
| | | | Networks, | network |
| | | | Inc. | |
| US10142392B2 | 2007-01-24 | 2018-11-27 | Icontrol | Methods and systems for |
| | | | Networks, | improved system |
| | | | Inc. | performance |
| US10156959B2 | 2005-03-16 | 2018-12-18 | Icontrol | Cross-client sensor user |
| | | | Networks, | interface in an |
| | | | Inc. | integrated security |
| | | | | network |
| US10156831B2 | 2004-03-16 | 2018-12-18 | Icontrol | Automation system with |
| | | | Networks, | mobile interface |
| | | | Inc. | |
| US10200504B2 | 2007-06-12 | 2019-02-05 | Icontrol | Communication |
| | | | Networks, | protocols over internet |
| | | | Inc. | protocol (IP) networks |
| US10237806B2 | 2009-04-30 | 2019-03-19 | Icontrol | Activation of a home |
| | | | Networks, | automation controller |
| | | | Inc. | |
| US10237237B2 | 2007-06-12 | 2019-03-19 | Icontrol | Communication |
| | | | Networks, | protocols in integrated |
| | | | Inc. | systems |
| US9306809B2 | 2007-06-12 | 2016-04-05 | Icontrol | Forming a security |
| | | | Networks, | network including |
| | | | Inc. | integrated security |
| | | | | system components and |
| | | | | network devices |
| US9450776B2 | 2005-03-16 | 2016-09-20 | Icontrol | Forming a security |
| | | | Networks, | network including |
| | | | Inc. | integrated security |
| | | | | system components |
| US9628440B2 | 2008-11-12 | 2017-04-18 | Icontrol | Takeover processes in |
| | | | Networks, | security network |
| | | | Inc. | integrated with premise |
| | | | | security system |
| US10348575B2 | 2013-06-27 | 2019-07-09 | Icontrol | Control system user |
| | | | Networks, | interface |
| | | | Inc. | |
| US10339791B2 | 2007-06-12 | 2019-07-02 | Icontrol | Security network |
| | | | Networks, | integrated with premise |
| | | | Inc. | security system |
| US10365810B2 | 2007-06-12 | 2019-07-30 | Icontrol | Control system user |
| | | | Networks, | interface |
| | | | Inc. | |
| US10382452B1 | 2007-06-12 | 2019-08-13 | Icontrol | Communication |
| | | | Networks, | protocols in integrated |
| | | | Inc. | systems |
| US10389736B2 | 2007-06-12 | 2019-08-20 | Icontrol | Communication |
| | | | Networks, | protocols in integrated |
| | | | Inc. | systems |
| US8836467B1 | 2010-09-28 | 2014-09-16 | Icontrol | Method, system and |
| | | | Networks, | apparatus for automated |
| | | | Inc. | reporting of account and |
| | | | | sensor zone information |
| | | | | to a central station |
| US9729342B2 | 2010-12-20 | 2017-08-08 | Icontrol | Defining and |
| | | | Networks, | implementing sensor |
| | | | Inc. | triggered response rules |
| US6549128B1 | 2001-09-28 | 2003-04-15 | Bellsouth | Method, system, and |
| | | | Intellectual | apparatus for remotely |
| | | | Property | provisioning network |
| | | | Corporation | elements to eliminate |
| | | | | false alarms |
| US7259656B1 | 2001-11-13 | 2007-08-21 | Ch2M Hill | System and method for |
| | | | Industrial | displaying safe exit |
| | | | Design & | routes during an |
| | | | | emergency condition |
| | | | Construction, | |
| | | | Inc. | |
| US7197514B2 | 2002-08-09 | 2007-03-27 | 3M | Managing information |
| | | | Innovative | relating to firestopping |
| | | | Properties | systems |
| | | | Company | |

1. A system to provide 24 hour-a-day, 7 day-a-week, offsite site, wireless communicating, monitoring system by a trained operator to detect and evaluate threats of fire offsite and when deemed appropriate, initiate a gel-based fire protection system.

2. A self-contained exterior modular fire sprinkler system for residential, moderate commercial, and light industrial use, said system comprising:
(a) A skid-mounted packaged, generally rectangular, system containing such pumps, mixing tanks, independent water and electricity supply as needed to deploy the water-gel mix to the structure and defensible spaces as needed.
(b) A central circuit board control panel (“OCC”) to receive wireless signals from the trained system operator to deploy, purge, and redeploy as and when needed.
(c) Cameras equipped with thermal and video imaging to alert the system operator and for the system operator to monitor the site and neighboring areas for threat of fire via said wireless communication system.
(d) A combination of water inlet/outlets manifold attached to said skid, said manifolds consisting of an assembly providing for the opening and closing of valves to release the gel-water mixture, maintain pressure, and shut down said gel-water based fire suppression mix, purge the system once deployed, and redeploy additional gel-water as and if needed.
(e) A set of fluid storage tanks to contain an independent supply of water, purge water, gel, and a mixing tank.
(f) A set of 6-volt DC, AGM Deep Cycle Sealed Lead Acid batteries to provide independent back-up electricity supply. Another embodiment, where appropriate, applies a standard diesel or gasoline powered auto-start electric generator; another embodiment, as an option to the site owner, is to provide back-up power for the structure itself;
(g) “Trickle charge” battery charger to keep the batteries charged while grid-based electricity supply is available;
(h) A pump to transmit the gel-water mix to the exterior sprinklers to provide 4-8 hours of protection to the structure(s) and defensible spaces as and if this embodiment has been included in the system;
(i) A sensor to detect when and if the grid-based electricity supply is cut-off and automatically switch to the battery pack.

3. A communication system that enables both wireline and wireless communication between the site systems and sensors, the FDC, 1^{st} responders, and other sources of important information about threats facing the site (e.g., weather services).

4. The system of claim 1 wherein the system OCC shuts off onsite fuel supplies (e.g., propane) through valves connected via wireless to the OCC and when so commanded by the FDC, onsite operator, or through the system autonomous function (see also claims 25, 26, and 27)

5. Sprinkler heads with sizing to accommodate the gel-water mix with minimum friction losses, minimum potential for clogging, and maximum capability to be purged after use.

6. Use of a gel-water mix that has been approved by the appropriate authorities for use in structural and vegetative fires and is environmentally certified as a “green technology.

7. The FDC monitoring system of claim 1, including:
(a) An interconnected system of devices disposed at different locations throughout a monitored facility, each device being adapted to generate a condition signal that varies in response to changing conditions proximate the device to alternatively indicate at least two different states;
(b) A computer-based CPU for storing facility mapping information, location information and device image information;
(c) Said FDC having an image generator adapted to produce a visible image including a map depicting the monitored facility and device images displayed on the map to depict the location of the devices;
(d) A communication circuit to link the devices and the FDC to provide status/condition signals as inputs to an image generator programmed to selectively adjust the device images in response to the condition signals, and to provide instantaneous visual reports regarding the device's state with respect to that associated device.

8. The system of claim 1 whereby the condition signal instantaneously changes on the computer screen at least one of the following characteristics of the device: its color, shape, or flashing.

9. The system of claim 2 wherein the computer screen depicts the present operating state and condition of each component of the system whether: (a) idle and functional, (b) idle with fault detected, (c) operating, (d) purging.

10. The system of claim 2 wherein the representation on the computer screen depicts whether the overall system is in a standby state, a fault state, and or alarm state.

11. The system of claim 1 through which the OCC is communicating with the FDC and others, as needed, whether such communication pathway is operating properly and, if not, a warning signal is generated.

12. The system of claim 1 such that the FDC is coupled to the OCC in a manner to receive device information from each device coupled to the OCC and thereby added to a circuit governed by the OCC, and based on the information received, generate a list of devices in the circuit and their present status (see claim 8).

13. The system of claim 6 such that the computer screen image generator displays a site map of the structure(s) and associated layout of the pipelines and sprinklers.

14. The system of claim 7 through which the computer screen image generates the device images standardized shapes such that the FDC operator and site personnel are able to identify readily and quickly what component of the system that specific device is without having to refer to a “code book”.

15. The system of claim 5 through which the FDC facility receives textual descriptive information in a standard format regarding operating standards, faults, procedures, and protocols for deploying or purging the system.

16. The system of claim 1 though which the present condition of the system at the FDC and onsite is continuously stored in graphic and textural forms on a permanent storage device such as a computer hard drive.

17. The system of claim 10 through which the FDC is advised visually and texturally that control of the system at the site has been assumed by someone at the site by activating the requisite code in the OCC.

18. The system of claim 10 through which the operating history and commands from either the FDC operator or onsite are collected and stored in a permanent storage device such as a computer hard drive.

19. The system of claim 12 through which the image display(s) and maps may be adapted to display any changes to the system that occur after installation

20. The system of claim 1 through which a completely redundant monitoring and control back-up system works in the event that the primary monitoring and control system goes off-line for any reason, and such that the data from claim 17 stores the record of any such switch from primary to secondary.

21. The system of claim 18 through which the FDC operator makes appropriate changes to the display images and maps to reflect the changes that occur pursuant to claim 18.

22. The system of claim 15 through which the permanent storage includes a systematic textural and visual master list of all of the information in the permanent storage device that is readily accessible and readable in a standardized, easy-to-read, format.

23. The system of claim 19 including a means for selecting from and retrieving from the master list only that information that the FDC operator desires at that specific time.

24. The system of claim 18 through which images are displayed in a readily and quickly understood standardized format of visible images.

25. A system of the OCC by which an authorized owner/occupant/manager of the site may, in specified emergency situations (e.g. wireless communication is lost and the threat of fire is imminent), unlock the OCC control system and manually operate the system.

26. A system of claim 25 through which if no one is on site and certain emergency conditions exist, an authorized person may control the system offsite through a preset cellphone APP.

27. A system of claim 25 through which if no one is on site and certain emergency conditions exist, an autonomous operating system is initiated at the OCC to operate the system through those emergency conditions.
